(19) United States
(12) Patent Application Publication
(10) Pub. No.: US 2026/0135758 A1
(43) Pub. Date: May 14, 2026

(54) ENHANCING LANGUAGE MODELS FOR NETWORK MANAGEMENT

(71) Applicant: Cisco Technology, Inc., San Jose, CA (US)

(72) Inventors: Sanjay Kumar Hooda, Pleasanton, CA (US); Robert Edgar Barton, Richmond (CA); Swati Garg, Cupertino, CA (US); Jerome Henry, Pittsboro, NC (US); Madhavan Kasthurirangan, Palo Alto, CA (US); Samer Salam, Beirut (LB); Shyamsundar N. Maniyar, San Jose, CA (US); Frank Brockners, Koln (DE); Vinay Saini, Bangalore (IN)

(21) Appl. No.: 18/941,522

(22) Filed: Nov. 8, 2024

(51) Int. Cl. H04L 41/0823; G06F 40/35; G06F 40/58; H04L 41/16

(52) U.S. Cl. CPC H04L 41/0823; G06F 40/35; G06F 40/58; H04L 41/16

(57) ABSTRACT

Techniques for providing a language model with dynamic configuration data for network devices in a network that is then used by the language model to generate network-contextual responses to prompts received at the language model. A network controller may collect configuration data from the network devices where the configuration data includes device configurations of the network devices. The network controller may further receive a prompt from a network operator to which the language model is to respond and identify a relevant device configuration that is contextually relevant to the prompt. Further, the network controller may provide the prompt and the relevant device configuration to the language model, generate, by the language model and using the relevant device configuration, a response to the prompt, and provide the network operator with an indication of the response to the prompt.

### TECHNICAL FIELD

The present disclosure relates generally to provisioning language models on network controllers (and/or other network devices) to improve the ability of the network controllers to manage a network and interact with network operators.

### BACKGROUND

Computer networks, or groups of connected computers or other devices that use communication protocols to exchange data, have continued to become more complex. The difficulties in managing these complex networks brought about the introduction of network controllers, such as those used in Software-Defined Networking (SDN). Network controllers play a pivotal role in network management by centralizing control over network devices and acting as a single point of management for configuring, monitoring, and optimizing network traffic flows across network infrastructure. Using communication protocols like OpenFlow, controllers communicate with network devices and instruct them on how to handle traffic based on policies and network conditions. Controllers abstract network control from physical hardware, enabling dynamic, programmable network management that adapts swiftly to changing demands. This centralized approach enhances scalability, agility, and operational efficiency, empowering administrators to enforce consistent network policies and security measures seamlessly across the entire network infrastructure.

Controllers have become well-adopted in the industry for centralized on-boarding, configuration, and management of network elements. Network operators often use command line interfaces (CLIs) and Application Programming Interfaces (APIs) to communicate with controllers. However, administration using CPIs and APIs is clunky, inefficient, and generally slow unless the administrator has gained a mastery of the CLI over many years. For instance, network operators generally have to know what specific CLI commands to use in order to interact with controllers and understand the results that are returned from the CLI or API commands, which are often difficult to understand. Accordingly, it can be difficult for network operators to quickly and effectively interact with network controllers using CLIs or APIs.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a controller runs a language model that utilizes contextual configuration data for a network to determine automation tasks and provide network insights for network operators.

FIGS. 2A and 2B collectively illustrate a flow diagram of an example method for using a language model to create embeddings for configuration data of network devices and providing the language model with a relevant embedding to determine a network-contextual response to the prompt.

FIG. 3 illustrates an example component diagram of a management device that creates embeddings for configuration data of network devices, and provides a language model with a relevant embedding to determine a network-contextual response to the prompt.

FIG. 4 illustrates an example system-architecture diagram in which a language model converts configuration data from a computer-readable format into a natural-language format.

FIG. 5 illustrates an example system-architecture diagram in which a language model is used to generate an automation script used to implement a change to a network.

FIG. 6 illustrates a flow diagram of an example method for providing a language model with contextual configuration data for a network to determine responses to prompts of network operators.

FIGS. 7A and 7B collectively illustrate a flow diagram of an example method for using a language model to create embeddings for configuration data of network devices and providing the language model with a relevant embedding to determine a network-contextual response to the prompt.

FIG. 8 is a computer architecture diagram showing an example computer architecture for a device capable of executing program components that can be utilized to implement aspects of the various technologies presented herein.

### DESCRIPTION OF EXAMPLE EMBODIMENTS

### Overview

The present disclosure relates generally to converting dynamic, network-contextual data for a network into a natural-language format, creating embeddings for the network-contextual data, and storing the embeddings in a vector database. A language model for the network may then find a contextually relevant embedding for a prompt from a network operator, and generate a response to the prompt using the contextually relevant embedding.

A first method described herein may include deploying a language model that is configured to respond to prompts from network operators associated with the network. Additionally, the first method may include collecting configuration data from network devices in the network where the configuration data including device configurations of the network devices. The first method may further include receiving a prompt from a network operators to which the language model is to respond, and identifying, from the device configurations, a relevant device configuration that is contextually relevant to the prompt. Further, the first method may include providing the prompt and the relevant device configuration to the language model, generating, by the language model and using the relevant device configuration, a response to the prompt, and providing the network operators with an indication of the response to the prompt.

A second method described herein may include deploying a language model that is configured to respond to prompts from network operators associated with a network, and collecting network data for the network where the network data indicates network operating conditions of the network. Additionally, the second method may include, using the language model, converting the network data from a computer-readable format into a natural-language format. The second method may further include generating, using the network data, embeddings representing the network operating conditions of the network, and storing, in a vector database associated with the language model where the embeddings. Additionally, the second method may include receiving a prompt from a network operator to which the language model is to respond, and generating a first embedding that represents the prompt. The second method may further include identifying a relevant network operating condition that is contextually relevant to the prompt by performing a similarity search of the vector database with the first embedding. Even further, the second method may include generating, by the language model and using the relevant network operating condition, a response to the prompt, and providing the network operator with an indication of the response to the prompt.

Additionally, the techniques of at least the first method and the second method and any other techniques described herein, may be performed by a system and/or device having non-transitory computer-readable media storing computer-executable instructions that, when executed by one or more processors, performs the method(s) described above.

### EXAMPLE EMBODIMENTS

This disclosure describes techniques for providing a language model with dynamic configuration data for network devices in a network that is used by the language model to generate network-contextual responses to prompts received at the language model. Network operators (also referred to herein as “network administrators”) connect to network devices and once authenticated, can use network device CLIs (and APIs) to issue prompts and commands. However, CLI administration is clunky, inefficient, and generally slow unless the administrator has gained a mastery of the CLI over many years. For instance, network operators generally have to know what specific CLI commands to use in order to troubleshoot devices and understand the results that are returned from the CLI commands, which are often difficult to understand. Accordingly, it can be difficult for network operators to quickly and effectively interact with network devices using CLIs. Rather than managing a network using CLIs or APIs, the language model may be utilized to answer prompts from network operators or otherwise manage the network.

Various types of virtual agents have emerged over the years with the purposes of interacting with and providing assistance to users as though they are human assistants. One type of virtual agent, known as a chatbot, is a computer program that has conversations with users through text or speech. Traditionally, chatbots operated under rule-based systems where rules and decision trees were used to recognize specific words or phrases provided by users, and provide predefined responses to the users based on these words or phrases. However, these chatbots were fairly limited and had difficulties handling unexpected or complex queries from users. Thus, while rule-based chatbots could handle basic tasks, these chatbots had fairly limited usefulness and provided little value for users.

More recently, there have been advances in artificial intelligence (AI) that have enabled chatbots and other AI systems to perform complex tasks that normally require human intelligence. Generative AI is a type of artificial intelligence where models are used to create (or “generate”) new content based on inputs, often in the form of prompts from users. One type of generative AI model is particularly effective at generating text, specifically, the language model (e.g., the large language model (LLM)). Language models are trained on large sets or corpuses of text data to perceive and infer context from user queries, understand a broader range of queries, and generate human-like textual responses to the queries. Chatbots that are backed by language models are becoming increasingly popular among users due to their ability to perform complex tasks on behalf of users.

Language models may be utilized according to the techniques described herein to replace (or augment) the CLI and assist network operators that are interacting with network devices, such as by interpreting debugs, investigating on-board logs, explaining configuration snippets, and even generating commands on behalf of operators. Using language models for this purpose may be advantageous because language models can accept and understand plain language prompts such that the network operators need not know specific CLI prompts or API calls. However, there are limitations to simply using an off-the-shelf language model to generate responses to the prompts. For instance, the model has no contextual knowledge of the topology or devices that are currently in the network, and also has no knowledge of software versions, hardware compatibility of features, number and type of interfaces in use, and so forth.

To solve these issues and as described herein, a controller (or other entity) may dynamically collect the configuration data (e.g., device configurations, topology data, etc.) from the network, and store the configuration data for use by the language model. The language model may then use relevant portions of the configuration data to provide network-contextual responses to prompts. Generally, the prompts provided to the language model are in a natural-language format, but the configuration data collected from the network is often in a computer-readable format (e.g., Python, REST APIs, Netconf and Yang, etc.). This may be problematic as many retrieval methods that are used to find relevant information for a prompt (e.g., cosine similarity, Euclidean distance, etc.) are less accurate when comparing data or information in different formats. According to the techniques described herein, the language model may be utilized to convert the configuration data from the computer-readable format into the natural-language format. After being converted into the natural-language format, the configuration data may be converted into embeddings using an embedding model, and stored in a vector database as embeddings.

After the vector database has been populated with embeddings representing the real-time, or near-real time, configuration data, the language model may be provided with relevant portions of the configuration data for prompts using techniques such as Retrieval Augmented Generation (RAG). For instance, a received prompt may be converted into an embedding which is then used in retrieval to identify configuration data in the vector database that is contextually relevant to the prompt (e.g., using cosine similarity or other methods for measuring the similarity between vectors or data points). Once a contextually relevant portion of the configuration data is retrieved from the vector database, the relevant configuration data may be provided to the language model. The language model may then use the relevant configuration data for the network along with the prompt to determine a network-contextual response for the prompt.

In some instances, the prompt may be a simple command to pull data from the network, such as a network operator providing a prompt of “is BGP configured on my switch named user_access_9300” to the language model. The prompt may be converted into an embedding and used to find context data for the switch named “user_access_9300” such that the language model can provide a current, relevant answer to the network operator. Accordingly, the prompts may be simple commands to read data or write data that are relatively straightforward for the language model to answer.

However, in some examples the prompts may be more complex commands for the language model, such as commands to generate automation scripts for the controller to perform a network operation. As an example, a network operator may submit a prompt of “would you please create an EVPN overlay for guest wireless users of my network architecture” to the language model. For more complex commands, the language model may engage in a back-and-forth conversation to obtain the necessary information to accomplish the task. Following the above example, the language model may determine that the prompt is a request to create an EVPN overlay and ask follow-up questions for details that are needed to create the overlay, such as “do you prefer using the same VLAN numbers in each site for consistency, or different VLAN numbers for unique traceability?” The language model may continue to engage in a conversation until the details are obtained to fulfill the request. As part of this conversation, the language model may learn preferences of the network operator, such as semantic preferences. In this example, the language model may determine that the network operator prefers to use the same VLAN numbers across sites and may store this preference in a local database populated with preference documents. For future automation scrips, the language model (and/or another entity) may access this local database to determine if the network operator has any relevant preferences for responding to a prompt.

After using the network-contextual data for the network, the language model may generate a response to the prompt received from the network operator. In some instances, the response may simply be a text-based response that provides the network operator with an answer to a question about the network. In other examples, the language model may output an automation script for review by the network operator before implementation. Upon approving the automation script (and/or providing changes or feedback), the language model may provide the automation script to a network controller or other device to implement for the network.

Generally, the controller may maintain an inventory and/or topology of the different network devices in the network, and may further obtain device information for the devices. For instance, the controller may use various commands to obtain comprehensive diagnostic reports from network devices (e.g., “show tech” command). The device information may include hardware information, software versions, configurations of the network devices (e.g., settings for interfaces, routing protocols, security features, etc.), system resources (e.g., utilization of CPU or memory, buffer pools, etc.), status information, routing and switching information logs and events, diagnostic and debugging information, and various types of telemetry data. The controller may examine the details for each network device and determine the device types or roles of the devices, the hardware model, the capabilities of the devices, the resource constraints of the devices (e.g., supports 10B parameters, maximum of 3.5 Gigabytes (GB) of memory, 20 tokens of processing speed, etc.), and what services or features the network device is using (e.g., Layer 2(L 2 ) or L3 security, Quality of Services (QoS) policies, overlay services, routing protocols, etc.).

This information may be converted into natural-language embeddings and stored in the vector database as described herein. The controller may further be configured to utilize various management protocols in order to determine if any network information has changed. For instance, the controller may determine if devices have been added or removed from the network, if configurations of a device have changed, if a network topology has changed, and/or any other changes to the network have occurred. In response to determining that a change has been made, the controller may work with the language model to update the configuration data embeddings to ensure that an up-to-date representation of the network is available to the language model when responding to prompts.

While some of the techniques are described herein as being performed by a language model operating on a network controller, some or all of the techniques may be performed by other devices. In some examples, the language model may be deployed on a different device in the network (e.g., a switch, router, server, etc.). In further examples, a dedicated service may be created for the networks that performs the techniques, and/or a remote service may be employed, such as a cloud-based service, to perform some or all of the techniques. Further, while the techniques are described with respect to language models, such as LLMs and small language models (SLMs), any type of models may be used. That is, the models may not necessarily comply with the definitions of LLMs and SLMs, and other types of AI language models capable of generating responses to prompts of users may be utilized herein.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

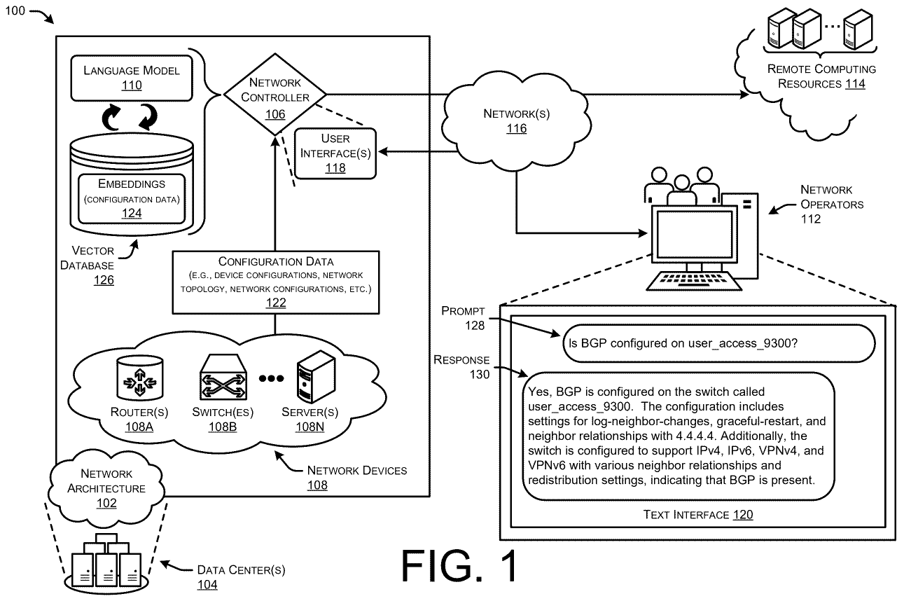

FIG. 1 illustrates a system-architecture diagram of an environment 100 in which a controller runs a language model that utilizes contextual configuration data for a network to determine automation tasks and provide network insights for network operators.

The environment 100 may include a network architecture 102 that, in some examples, may comprise devices housed or located in one or more data centers 104. The network architecture 102 may include one or more networks implemented by any viable communication technology, such as wired and/or wireless modalities and/or technologies. The network architecture 102 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network architecture 102 may include devices, virtual resources, or other nodes that relay packets from one network segment to another by nodes in the computer network. The network architecture 102 may include multiple devices that utilize the network layer (and/or session layer, transport layer, etc.) in the OSI model for packet forwarding, and/or other layers. The network architecture 102 may include various network devices 108, such as routers 108A, switches 108B, gateways, firewalls, smart NICs, NICs, ASICs, FPGAs, servers 108N, and/or any other type of device. Further, the network architecture 102 may include virtual resources, such as VMs, containers, and/or other virtual resources. However, the network architecture 102 may be of a different type of architecture, such as a WAN, IoT network, cellular network, or any other type of network.

The one or more data centers 104 may be physical facilities or buildings located across geographic areas that designated to store networked devices that are part of the network architecture 102. The data centers 104 may include various networking devices, as well as redundant or backup components and infrastructure for power supply, data communications connections, environmental controls, and various security devices. In some examples, the data centers 104 may include one or more virtual data centers which are a pool or collection of cloud infrastructure resources specifically designed for enterprise needs, and/or for cloud-based service provider needs. Generally, the data centers 104 (physical and/or virtual) may provide basic resources such as processor (CPU), memory (RAM), storage (disk), and networking (bandwidth). However, in some examples the devices may not be located in explicitly defined data centers 104, but may be located in other locations or buildings.

A network controller 106 may perform various techniques for managing the network architecture 102 and the network devices 108 therein. For instance, the network controller 106 may manage network behavior and policies, network configuration and provisioning, traffic engineering and optimization, policy enforcement, visibility and monitoring, and other network management operations. In some examples, network operators 112 work with the network controller 106 to ensure that their network architectures 102 are exhibiting desired characteristics, such as enforcing desired policies, implementing desired device configurations, or managing access to devices.

The network operators 112 may connect to the network devices 108 via one or more user interfaces 118 and once authenticated, can use the interface(s) user interfaces 118 to issue prompts and commands for the network devices 108. The interfaces 118 may be web-based portals, application interfaces, websites, CLIs, APIs, and/or any other interface through which data may be communicated. According to the techniques described herein, the user interface(s) 118 may receive prompts or other data from the network operators 112 via text interfaces 120 that receive inputs from the network operator 112. In some instances, the network controller 106 may host or run a language model 110 that utilizes embeddings 124 that are stored in a vector database 126 to respond to prompts from network operators 112.

The network controller 106 may periodically, continuously, and/or on-demand, obtain various configuration data 122 from the network of network devices 108. The configuration data may include network configurations, device configurations, network topology data, and/or other types of data associated with a network and/or network devices 108. For instance, the network controller 106 may maintain an inventory or catalogue of the different network devices 108 in the network architecture 102 and may further obtain device information for the network devices 108. The network controller 106 may use various commands to obtain comprehensive diagnostic reports from network devices 108 (e.g., “show tech” command). The device information may include hardware information, software versions, configurations of the network devices (e.g., settings for interfaces, routing protocols, security features, etc.), system resources (e.g., utilization of CPU or memory, buffer pools, etc.), status information, routing and switching information logs and events, diagnostic and debugging information, and various types of telemetry data. The network controller 106 may examine the details for each network device 108 and determine the device types or roles of the devices, the hardware model, the capabilities of the devices, the resource constraints of the devices (e.g., supports 10B parameters, maximum of 3.5 Gigabytes (GB) of memory, 20 tokens of processing speed, etc.), and what services or features the network device 108 is using (e.g., Layer 2(L 2 ) or L3 security, Quality of Services (QoS) policies, overlay services, routing protocols, etc.).

The network controller 106 (or other entity) may dynamically collect the configuration data 122 (e.g., device configurations, topology data, etc.) from the network, and store the configuration data 122 for use by the language model 110. The language model 110 may then use relevant portions of the configuration data 122 to provide network-contextual responses to prompts. Generally, the prompts provided to the language model 110 are in a natural-language format, but the configuration data 122 collected from the network is often in a computer-readable format (e.g., Python, REST APIs, Netconf and Yang, etc.). This may be problematic as many retrieval methods that are used to find relevant information for a prompt (e.g., cosine similarity, Euclidean distance, etc.) are less accurate when comparing data or information in different formats. According to the techniques described herein, the language model 110 may be utilized to convert the configuration data 122 from the computer-readable format into the natural-language format. For instance, the language model 110 may be given the configuration data 122 along with a command to convert the configuration data 122 into a natural-language format.

In some instances, the language model 110 may simply generate natural language summarization of the configuration data, such as sentences, paragraphs, or bullet points explaining the configuration data 122 in natural-language, human-readable formats. In some instances, the language model 110 may convert the configuration data 122 into a syntax or semantic that is easily converted into embeddings 124. For instance, the configuration for each network device 108 may be broken into multiple sections of “Device Name: Feature-configuration” where the device name is unique. These configuration sections may be converted into the corresponding natural-language description by the language model 110. As an example the prompt consists of “you are a helpful AI assistant. Please analyze the following configuration from a Cisco Catalyst 9300 switch, and be sure to include the hostname of the switch in the summary′+‘Device-Name: Config Sections’.”

After being converted into the natural-language format, the configuration data 122 may be converted into embeddings 124 using an embedding model, and stored in a vector database 126 as embeddings 124. Generally, the embedding model converts the configuration data 122 into embeddings 124 by first preprocessing the raw data, such as tokenizing text. The configuration data 122 is then represented numerically, often using one-hot encoding or TF-IDF. A neural network architecture, like Word2Vec or BERT, is trained on a large dataset to learn dense vector representations that capture semantic meaning. After training, new data points are converted into embeddings 124 and stored in the vector database 126, where similar items are closer in the vector space. These embeddings 124 can be fine-tuned for specific tasks and used in applications like clustering or classification. In this way, the vector database 126 may be populated by embeddings 124 representing the configuration data 122 that is usable by the language model 110 to answer prompts.

There have been advances in artificial intelligence (AI) that have enabled chatbots and other AI systems to perform complex tasks that normally require human intelligence, such as perceiving, synthesizing, and inferring information. Generally speaking, AI systems and models ingest large amounts of data (or “training data”), analyze this data to identify correlations and patterns, and use these patterns to make predictions about future states. Although AI programs and algorithms have been around for decades, the amount of data and computing power needed to train AI models that are useful for humans has not existed. However, there have been various technological breakthroughs and advances that have accelerated the usefulness of AI, such as advent of cloud computing that provides effectively unlimited compute, advances in specialized hardware (e.g., graphics processing units (GPUs)) that efficiently train and run these AI models, and the discovery of more efficient training algorithms.

Generative AI is a type of artificial intelligence where models are used to create (or “generate”) new content based on inputs, often in the form of prompts from users. One type of generative AI model is particularly effective at generating text, specifically, the large language model (LLM). Language models 110 are trained on large sets or corpuses of text data to perceive and infer context from user queries, understand a broader range of queries, and generate human-like textual responses to the queries. Chatbots that are backed by language models 110 are becoming increasingly popular among users due to their ability to perform complex tasks on behalf of users.

One type of neural network architecture that has gained popularity due to its ability to reduce the amount of time needed to train generative AI models is known as the Transformer model, or simply “Transformers.” Transformers apply a set of mathematical techniques, called attention or self-attention, to capture relationships in sequential data called tokens, such as words in a sentence. Transformers are able to detect subtle causal relationships between data elements in a series, including how even distant data elements influence and depend on each other. Unlike previous models that have to process tokens sequentially (e.g., Recurrent Neural Networks (RNNs)), transformers use an attention mechanism to process tokens simultaneously and calculate the attention weights, or strengths of relationships, between the tokens in successive layers. Because transformers can compute attention weights for all the tokens in parallel, the amount of time needed to train generative AI models using transformers is greatly improved over other training models.

Generative AI can be used to generate text that resembles human-like responses to prompts. Transformers are very effective in training the models used generate text, often referred to as language models 110. Language models 110 are trained on large sets or corpuses of text data to generate human-like textual responses to prompts. Language models 110 are generally trained in two stages, pre-training and fine-tuning. During the pre-training stage, language models 110 are trained on massive datasets of unlabeled text data (or “unsupervised learning”) where transformers allow the language models 110 to process and learn the patterns and relationships between words. During the fine-tuning stage, the language models 110 can be fine-tuned for specific tasks or prompts, such as summarizing content, answering questions, and text completion. There are generalized language models 110 that have been trained on sets of text data describing all types of content (e.g., data obtained from crawlers that scrape the public Internet). There are also specialized language models 110 that have been trained on specialized sets of data that are specific to a particular type of content, such as networking technology.

The language model 110 may simply be an off-the-shelf language model that is deployed to the network controller 106, but in other examples, the language model 110 may be fine-tuned for networking concepts in general, and potentially fine-tuned for the network that includes the network devices 108. Although illustrated as running on the network controller 106, the language model 110 and/or the vector database 126 may be running and/or stored in remote computing resources 114, such as a cloud computing platform, an on-premises computing resource, or other available computing resources. The remote resources 114 may be accessible over the network(s) 116 in order to interact with the language model 110 and/or vector database 126. In other examples, the language model 110 and/or vector database may run and be stored on network devices 108, such as a router 108A, switch 108B, server 108N, or other network device (e.g., IoT device, gateway device, etc.).

As shown, a network operator 112 may utilize a computing device to submit a prompt 128 via the text interface 120 that is provided to the network controller 106. In this example, the prompt 128 is a simple command to pull data from the network, specifically, a question for the language model 110 to answer “is BGP configured on my switch named user_access_9300?” The prompt 128 may be converted into an embedding and used to find context data for the switch named “user_access_9300” such that the language model 110 can provide a current, relevant answer to the network operator. In this example, the prompt 128 may be used to identify contextually-relevant configuration data 122 using techniques such as RAG. For instance, the prompt 128 that is converted into an embedding is then used in retrieval to identify configuration data in the vector database 126 that is contextually relevant to the prompt 128, such as by using cosine similarity or other methods for measuring the similarity between vectors or data points.

Once a contextually relevant portion of the configuration data 122 is retrieved from the vector database 126, the relevant configuration data 122 may be provided to the language model 110. The language model 110 may then use the relevant configuration data 122 for the network along with the prompt 128 to determine a network-contextual response for the prompt 128. In this example, the prompt 128 and the relevant configuration data 122 may be input into the language model 110, and the language model may generate the response 1130 shown in FIG. 1 discussing how BGP is configured on the switch in question. Accordingly, the response 130 is a contextually relevant response 130 that is specific to the network and a particular network device 108 (e.g., switch 108B).

According to the techniques described herein, the network controller 106 may communicate with remote computing resources 114 that generate language models 110. In some instances, however, the network controller 106 itself may generate the language models 110, but in other examples, the language models 110 may be generated by the remote computing resources 114. The remote computing resources 114 may be a cloud computing platform, an on-premises computing resource, or other available computing resources. The language models 110 may be LLMs, SLMs, or any type of language model 110. The language models 110 may be generalized language models for different networks (e.g., WAN networks, data center networks, IoT networks, cellular networks), or may be specialized language models that have been trained on device-specific data (e.g., router language models, switch language models, sensor language models, etc.).

The remote computing resources 114 may provide the network controller 106 with access to the language models 110 over one or more networks 116, and the network controller 106 may provide portions of the configuration data 122 over the network(s) 116. The network(s) 116 may include any viable communication technology, such as wired and/or wireless modalities and/or technologies. Networks 116 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The devices described herein may communicate using any type of protocol over the network 116, such as the transmission control protocol/Internet protocol (TCP/IP) that is used to govern connects to and over the Internet.

In some instances, the network controller 106 may periodically, continuously, or upon detecting a change in the network or network devices 108, refresh the configuration data 122 and update the embeddings 124 stored in the vector database 126 to represent the current state of the network or network devices 108. In this way, the techniques described herein result in the language model 110 being provided with dynamic, up-to-data configuration data 122 for the network and/or network devices 108 such that the responses 130 or operations performed are not out of date with respect to the network.

The interface(s) 118 may comprise any type of interface, such as CLIs, APIs, Graphical User Interfaces (GUIs), Web-Based Interfaces, voice interfaces, scripting languages, embedded interfaces, middleware platforms, and so forth. As shown, the network operators 112 may utilize a text interface 120 to communicate with the network devices 108 via the interface(s) 118. The text interface 120 may be any type of interface, including CLIs, chatbots, etc.

While some of the techniques are described herein as being performed by the network controller 106, some or all of the techniques may be performed by other devices. For instance, a dedicated service may be created for the network architecture 102 that performs the techniques, and/or a remote service may be employed, such as a cloud-based service, to perform some or all of the techniques. Further, while the techniques are described with respect to language models 110 (e.g., LLMs, small language models (SLMs)), any type of models may be used.

The network operators 112 may establish communication connections over the one or more networks 116 to communicate with devices in the network architecture 102, such as the network controller 106 of the network architecture 102 and the network devices 108. The network(s) 116 may include any viable communication technology, such as wired and/or wireless modalities and/or technologies. Networks 116 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network operators 112 may communicate using any type of protocol over the network 116, such as the transmission control protocol/Internet protocol (TCP/IP) that is used to govern connects to and over the Internet.

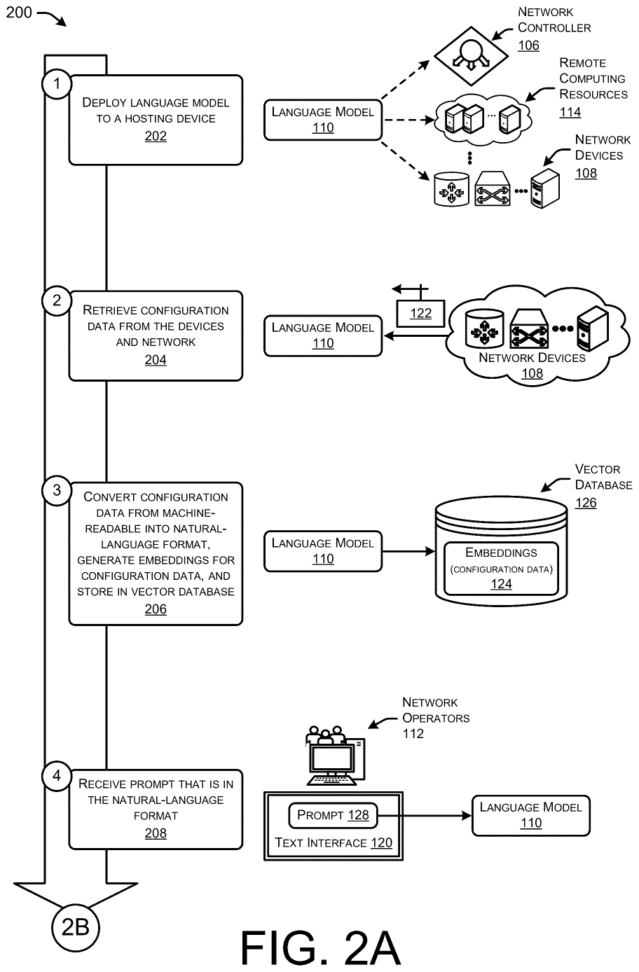

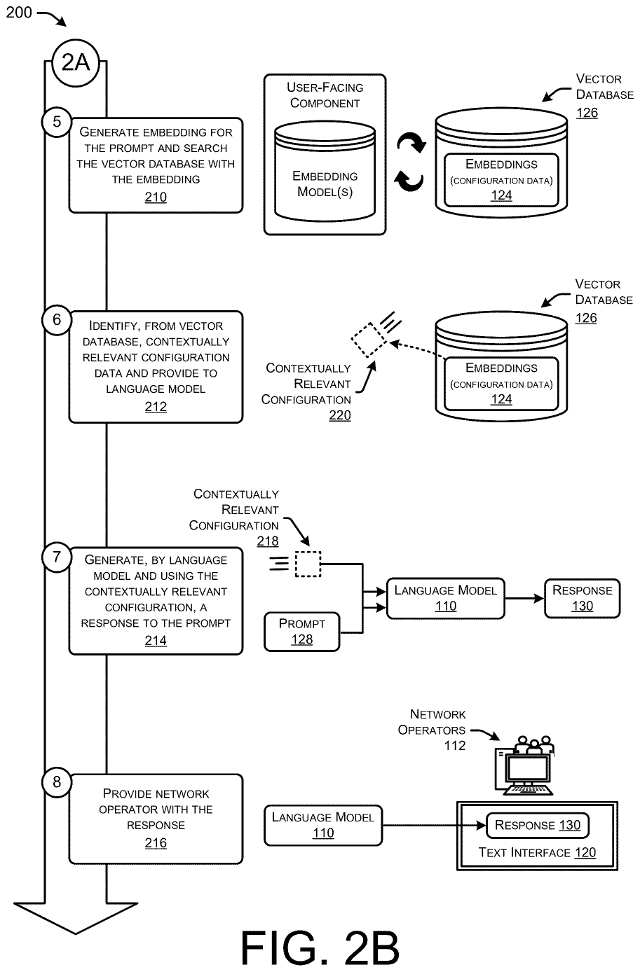

FIGS. 2A and 2B collectively illustrate a flow diagram 200 of an example method for using a language model 110 to create embeddings for configuration data 122 of network devices 108 and providing the language model 110 with a relevant embedding to determine a network-contextual response to the prompt 128.

At 202, a language model 110 may be deployed to a hosting device. In some examples, the hosting device is a network controller 106. In other examples, the language model 110 may be deployed to remote computing resources 114 (e.g., dedicated services, cloud-based services, etc.), and/or network devices 108 (e.g., routers, switches, gateways, etc.).

At 204, configuration data 122 may be retrieved from the network devices 108 and the network in general, and may be provided to the language model 110. In some instances, the configuration data 122 may be retrieved using one or more of SNMP (Simple Network Management Protocol), NetFlow, sFlow, REST APIs, OpenFlow, ICMP (Internet Control Message Protocol), LLDP (Link Layer Discovery Protocol), and so forth.

At 206, the language model may convert the configuration data 122 from a machine-readable format into a natural-language format, generate embeddings 124 for the configuration data 122, and store the embeddings 124 in the vector database 126. At 208, the language model 110 may receive a prompt 128 that is in the natural-language format. For instance, the network operator 112 may submit a prompt 128 in the form of text via the text interface 120 that is provided by the user interface(s) 118, and may be provided to a user-facing component of the system or device hosting the language model 110.

At 210, an embedding model may generate an embedding for the prompt 128 and the user-facing component may search the vector database 126 with the embedding. For instance, the user-facing component may measure the similarity between the embedding representing the prompt 128 and the embeddings 124 in the vector database 126 that represent the configuration data 122.

At 212, the user-facing component may identify, from the vector database 126, a contextually relevant configuration 220 and provide the contextually relevant configuration 220 to the language model 110. The contextually relevant configuration may be represented by the embedding 124 that is most (or nearly most) semantically similar to the embedding representing the prompt 128.

At 214, the language model 110 may generate, using the contextually relevant configuration 218, a response 130 to the prompt 128. For instance, the prompt 128 and the contextually relevant configuration 218 may be provided to the language model 110, and the language model 110 may utilize the contextually relevant configuration 218 to help generate the response 130 for the prompt 128.

At 216, the language model 110 may output the response 130 that is provided to the network operators 112. The response 130 may be provided via a user interface(s) 118 and through the text interface 120 for the network operators 112.

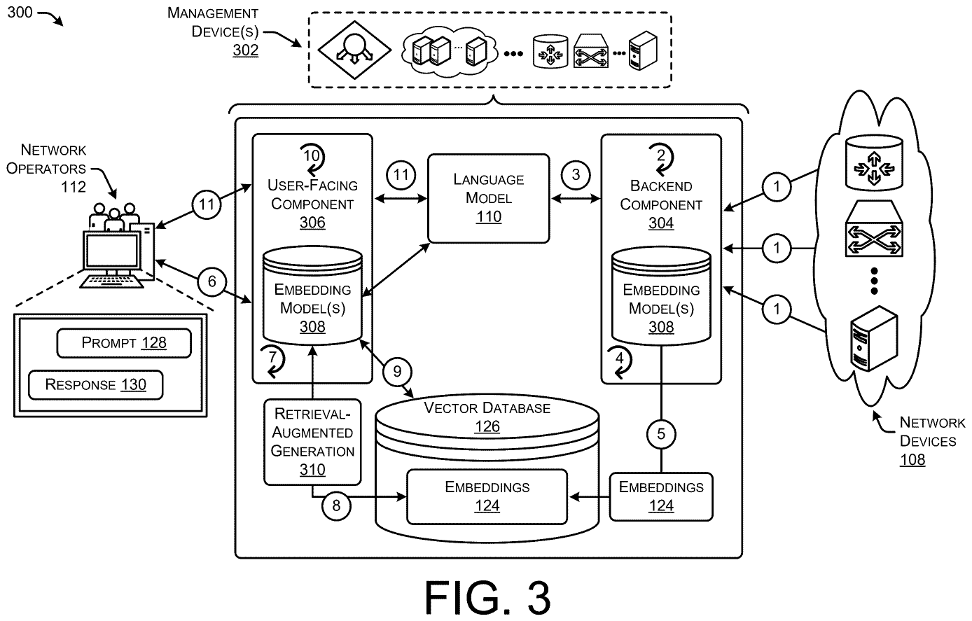

FIG. 3 illustrates an example component diagram 300 of a management device 302 that creates embeddings 124 for configuration data 122 of network devices 108, and provides a language model 110 with a relevant embedding to determine a response 130 for the prompt 128 that is network-contextual. The management device(s) 302 may be a network controller 106, remote computing resources 114, one or more of the various network devices 108, and/or any combination thereof.

At “1,” a backend component 304 of the management device(s) 302 may collect the configuration data 122. In some instances, the configuration data 122 may be retrieved using one or more of SNMP, NetFlow, sFlow, REST APIs, OpenFlow, ICMP, LLDP, and so forth. The configuration data 122 may be retrieved (or received depending on push/pull) periodically, continuously, in response to an event or change, and so forth.

At “2,” backend component 304 may break the configuration for each network device 108 into multiple sections of “Device Name: Feature-configuration.” That is, the backend component 304 may format the configuration data 122 to be converted into embeddings.

At “3,” the backend component 304 may work with the language model 110 to convert the configuration sections to the corresponding natural-language description. For instance, the backend component 304 may use the language model's 110 capability to take an appropriate prompt input and provide back the right natural-language description for the corresponding configuration sections. As an example, the prompt 128 may consist of “you are a helpful AI assistant, please analyze the following configuration from a Cisco Catalyst 9300 switch and be sure to include the hostname of the switch in the summary.”+“Device-Name: Config Sections”.

At “4,” once the backend component 304 has the natural-language description of the configuration data 122 received from the language model 110, the language model 110 may utilize an embeddings model 308 to create embeddings 124 from the natural-language description of the configuration sections which were returned by the language model 110 using proper context.

The embedding model(s) 308 may be any type of model configured to generate embeddings 124 by mapping text data, such as words, phrases, or sentences, into vector spaces. The resulting embeddings 124 capture semantic and syntactic information about the data, allowing language models 110 to work with and compare various forms of input more effectively. Various types of embedding model(s) 308 may be used to create the embeddings 124, such as word embeddings (e.g., Word2Vec, GloVe, etc.) that are trained to predict the context of a word (or vice versa), leading to embeddings that capture semantic similarities between words, as well as contextual embeddings (e.g., BERT, GPT, etc.), or models that use neural networks to understand the context in which words appear. The embeddings are dynamically generated based on surrounding words and the specific sentence or passage, capturing more nuanced meanings and relationships. The embedding model(s) 308 may analyze the configuration data 122 and/or other data in order to generate the embeddings 124. The resulting embeddings 124 may be stored in the vector database 126 where semantically similar words (or tokens) are located closer together in the vector space.

At “5,” the embeddings 124 are stored in the vector database 126, such as chromaDB, but any other vector database 126 can be used. At this stage, the system is ready to answer any natural-language questions (prompts) regarding the configurations of the network or network devices 108.

At “6,” a user-facing component 306 may receive a natural-language query or prompt 128 from a network operator 112 (or other user), and at “7,” the user-facing component 306 may create embeddings of the natural-language prompt using the embedding model(s) 308.

At “8,” the user-facing component 306 may use the vector database 126 to do a uses the vector database 126 to do a cosine similarity search for the retrieval step of Retrieval Augmented Generation (RAG) 310. That is, the embeddings 124 stored in the vector database 126 may be used by the user-facing component 306 for RAG 310. At “9,” the user-facing component 306 may initially retrieve relevant information from the vector database 126 using the prompt 128 from the network operator 112. This retrieval step may include the use of a retrieval model to search for documents or pieces of information that are most pertinent to the input query or context (e.g., cosine similarity, Euclidean distance, etc.).

At “10,” the user-facing component 306 may perform an augmentation step where the retrieved words or documents from the vector database 126 (e.g., embeddings 124) determined as relevant to the prompt 128 are used to augment the prompt 128 as it is placed into a context window of the language model 110. In this way, the language model 110 may be provided with additional, locally relevant information that can be used to generate more accurate and contextually appropriate responses. The language model 110 may then use the augmented prompt to produce a response. The resulting response benefits from the specific and relevant details provided by the retrieval step, improving its quality and relevance. At “11,” the response 130 may then be provided to the network operator 112 such that the response 130 is locally and contextually relevant to the network device 108 and/or network.

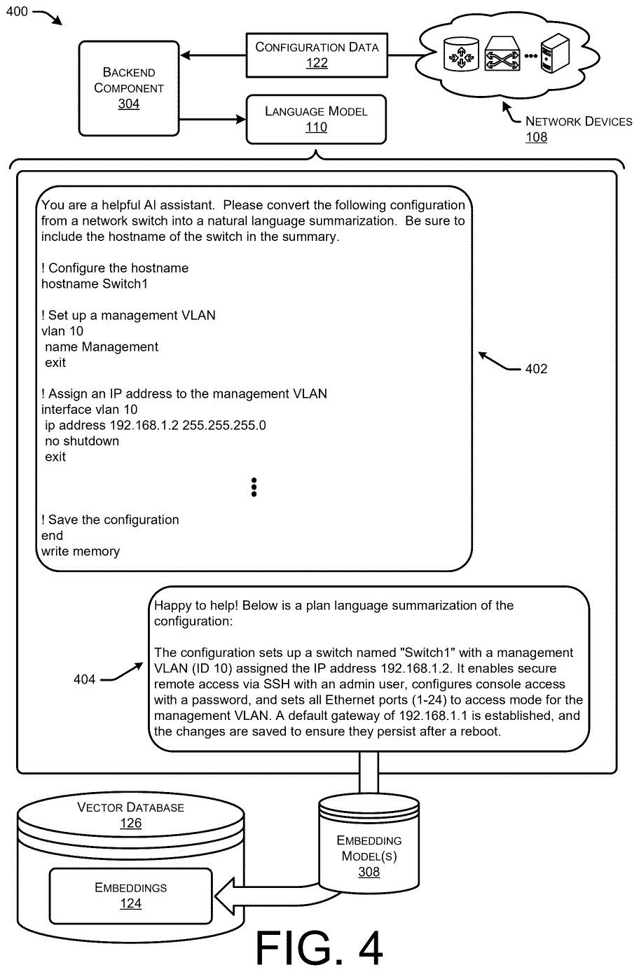

FIG. 4 illustrates an example system-architecture diagram 400 in which a language model 110 converts configuration data 122 from a computer-readable format into a natural-language format.

As shown, a conversion prompt 402 may include instructions for the language model 110 to convert configuration data from a switch into a natural language representation. The configuration of the switch is shown in the conversion prompt 402, but in some examples, the configuration of the switch may be placed into multiple sections of device name and feature configuration.

The language model may generate and provide a conversion response 404. The conversion response may include a natural-language summarization or representation of the configurations for the device, as requested in the conversion prompt 402. In some instances, the natural-language summarization may be a paragraph or other summary, but in some examples, the natural-language summarization of the configurations may be in a format suitable for creating embeddings.

The natural-language summarization may then be converted into embeddings 124 using an embedding model(s) 308. In some examples, the backend component 304 may iteratively prompt the language model 110 to convert portions of the configuration data 122 into natural-language representations that are then turned into embeddings 124.

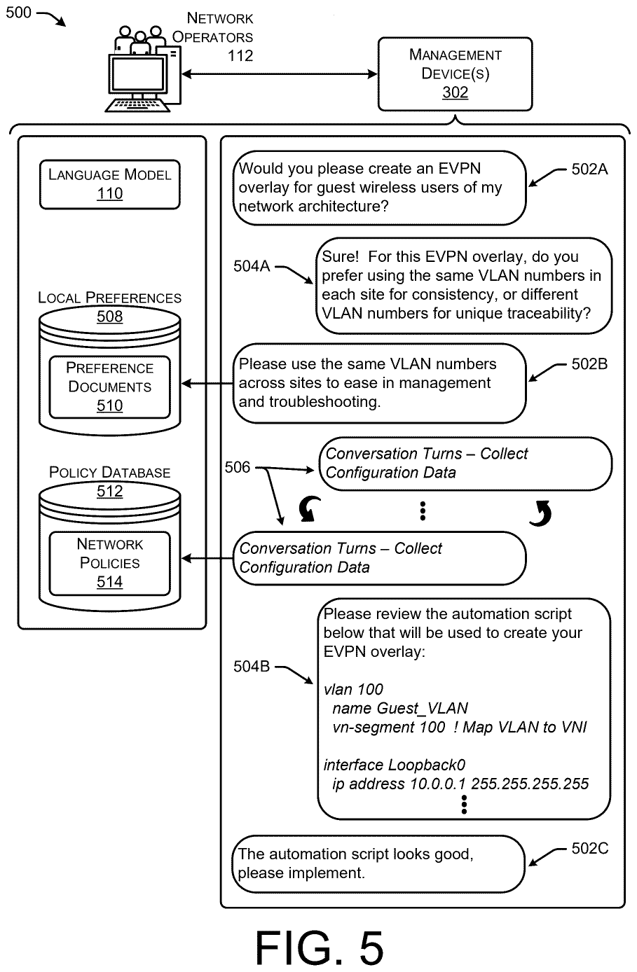

FIG. 5 illustrates an example system-architecture diagram 500 in which a language model 110 is used to generate an automation script used to implement a change to a network.

In some examples the prompts 128 may be more complex commands for the language model 110, such as commands to generate automation scripts for the management device(s) 302 to perform a network operation. As an example, a network operator may submit a first prompt 502A of “would you please create an EVPN overlay for guest wireless users of my network architecture” to the language model 110. For more complex commands, the language model 110 may engage in a back-and-forth conversation to obtain the necessary information to accomplish the task. Following the above example, the language model 110 may determine that the first prompt 502A is a request to create an EVPN overlay and ask follow-up questions for details that are needed to create the overlay, such as a first response 504A of “do you prefer using the same VLAN numbers in each site for consistency, or different VLAN numbers for unique traceability?” The language model 110 may continue to engage in a conversation until the details are obtained to fulfill the request. As part of this conversation, the language model 110 may learn preferences of the network operator 112, such as semantic preferences. As an example, in second prompt 502B, the network operator 112 may indicate that they would like to use the same VLAN numbers across sites. In this example, the language model 110 may determine that the network operator 112 prefers to use the same VLAN numbers across sites and may store this preference in a local preferences 508 database populated with preference documents 510. For future automation scrips, the language model 110 (and/or another entity) may access the local preferences 508 database to determine if the network operator 112 has any relevant preferences for responding to a prompt.

The language model 110 and network operator 112 may continue to determine configuration data for the requested EVPN overlay in one or more conversation turns 506. In some instances, the language model 110 (and/or another entity) may query a policy database 512 to determine if there are any network policies 514 that are relevant and need to be considered for the requested operation. For instance, the network policies may indicate what entities are allowed to cause the operation to be performed, and various rules for causing performance of the network operation (e.g., in which networks the operation may be performed, security best practices for the network operation, etc.).

After the conversation turns 506, the language model 110 may generate and present an automation script in a second response 504B asking the network operator 112 to review the automation script. In some instances, the automation script may be generated to incorporate, or consider, a network policy 514 determined to be relevant for the operation that is to be performed (e.g., create an EVPN overlay). The network operator 112 may provide a third prompt 502C that indicates the automation script looks good, and/or includes some changes or modifications for the automation script. The language model 110 may then output the automation script to a network service that implements changes to the network or network devices 108.

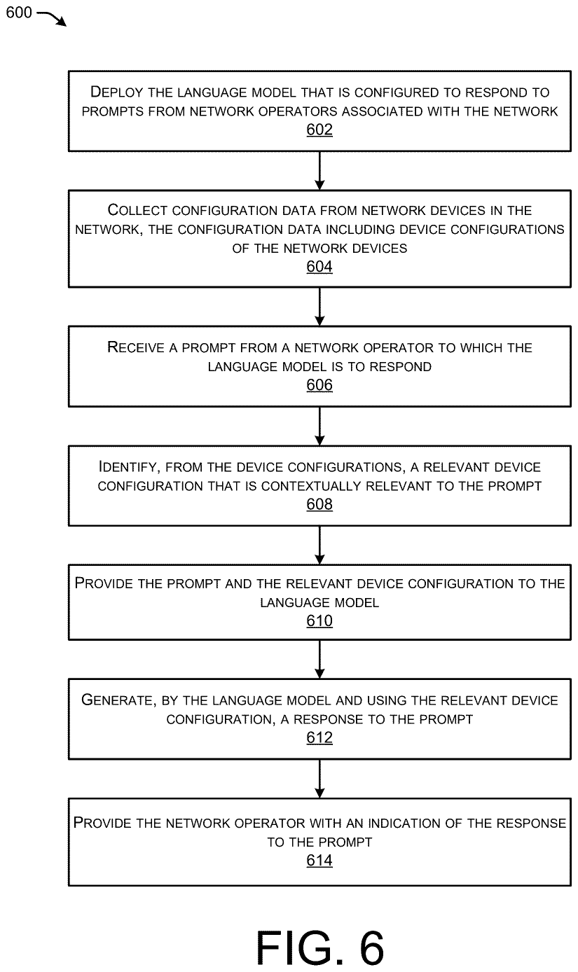

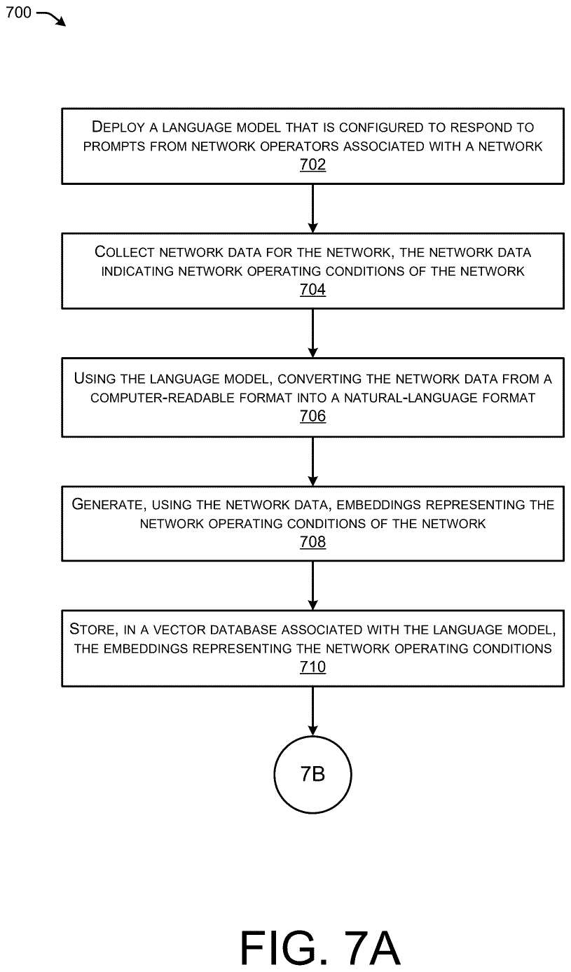

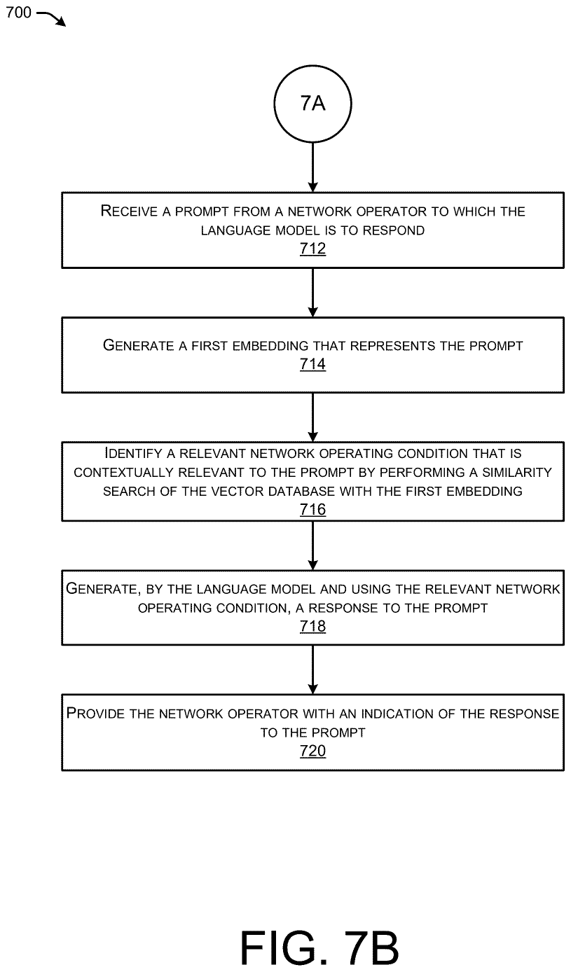

FIGS. 6, 7A, and 7B illustrate flow diagrams of an example methods 600 and 700 that illustrates aspect of the functions performed at least partly by the devices described in FIGS. 1-5, such as the network controller 106, the remote computing resources 114, and/or the network devices 108. The logical operations described herein with respect to FIGS. 6, 7A, and 7B may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in the FIGS. 6, 7A, and 7B and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

In some instances, the steps of methods 600 and 700 may be performed by a device and/or a system of devices that includes one or more processors and one or more non-transitory computer-readable media storing computer-executable instructions that, when executed by the one or more processors, cause the one or more processors to perform operations of methods 600 and 700.

FIG. 6 illustrates a flow diagram of an example method 600 for providing a language model 110 with contextual configuration data 122 for a network to determine responses to prompts of network operators.

At 602, the management device(s) 302 may deploy a language model that is configured to respond to prompts from network operators associated with a network. At 604, the management device(s) 302 may collect configuration data from network devices in the network where the configuration data including device configurations of the network devices. At 606, the management device(s) 302 may receive a prompt from a network operator to which the language model is to respond. At 608, the management device(s) 302 may identify, from the device configurations, a relevant device configuration that is contextually relevant to the prompt. At 610, the management device(s) 302 may provide the prompt and the relevant device configuration to the language model. At 612, the management device(s) 302 may generate, by the language model and using the relevant device configuration, a response to the prompt. At 614, the management device(s) 302 may provide the network operator with an indication of the response to the prompt.

FIGS. 7A and 7B collectively illustrate a flow diagram of an example method 700 for using a language model to create embeddings for configuration data of network devices and providing the language model with a relevant embedding to determine a network-contextual response to the prompt.

At 702, a management device(s) 302 may deploy a language model that is configured to respond to prompts from network operators associated with a network. At 704, the management device(s) 302 may collect network data for the network where the network data indicates network operating conditions of the network. At 706, the management device(s) 302 may, using the language model, convert the network data from a computer-readable format into a natural-language format. At 708, the management device(s) 302 may generate, using the network data, embeddings representing the network operating conditions of the network. At 710, the management device(s) 302 may store, in a vector database associated with the language model where the embeddings. At 712, the management device(s) 302 may receive a prompt from a network operator to which the language model is to respond. At 714, the management device(s) 302 may generate a first embedding that represents the prompt. At 716, the management device(s) 302 may identify a relevant network operating condition that is contextually relevant to the prompt by performing a similarity search of the vector database with the first embedding. At 718, the management device(s) 302 may generate, by the language model and using the relevant network operating condition, a response to the prompt. At 720, the management device(s) 302 may provide the network operator with an indication of the response to the prompt.

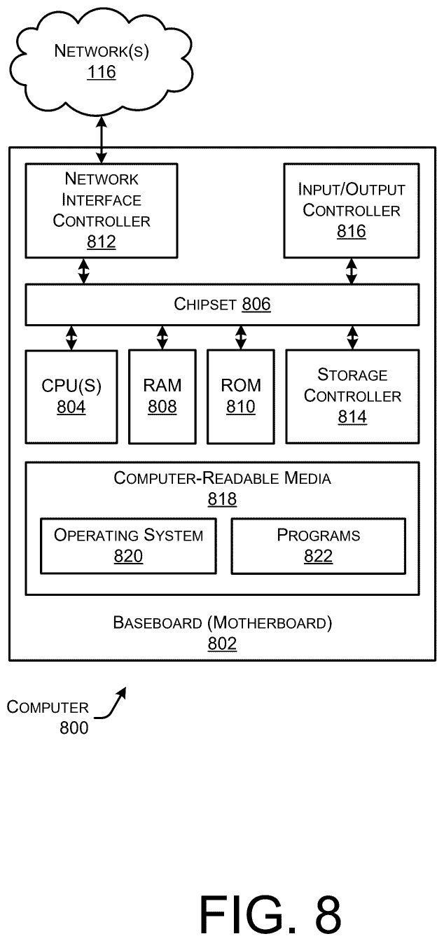

FIG. 8 shows an example computer architecture for a device capable of executing program components for implementing the functionality described above. The computer architecture shown in FIG. 8 illustrates any type of computer 800, such as a conventional server computer, workstation, desktop computer, laptop, tablet, network appliance, e-reader, smartphone, or other computing device, and can be utilized to execute any of the software components presented herein.

As described herein, the network controller 106 (and/or management device(s) 302) may be run on the computer 800, or multiple computers 800. Similarly, the computer 800 may be any type of device, such as network device 108. Thus, the computer 800 may, in some examples, correspond to any device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 800 includes a baseboard 802, or “motherboard,” which is a printed circuit board to which a multitude of components or devices can be connected by way of a system bus or other electrical communication paths. In one illustrative configuration, one or more central processing units (“CPUs”) 804 operate in conjunction with a chipset 806. The CPUs 804 can be standard programmable processors that perform arithmetic and logical operations necessary for the operation of the computer 800.

The CPUs 804 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 806 provides an interface between the CPUs 804 and the remainder of the components and devices on the baseboard 802. The chipset 806 can provide an interface to a RAM 808, used as the main memory in the computer 800. The chipset 806 can further provide an interface to a computer-readable storage medium such as a read-only memory (“ROM”) 810 or non-volatile RAM (“NVRAM”) for storing basic routines that help to startup the computer 800 and to transfer information between the various components and devices. The ROM 810 or NVRAM can also store other software components necessary for the operation of the computer 800 in accordance with the configurations described herein.

The computer 800 can operate in a networked environment using logical connections to remote computing devices and computer systems through a network, such as the network 116. The chipset 806 can include functionality for providing network connectivity through a NIC 812, such as a gigabit Ethernet adapter. The NIC 812 is capable of connecting the computer 800 to other computing devices over the network 116. It should be appreciated that multiple NICs 812 can be present in the computer 800, connecting the computer to other types of networks and remote computer systems.

The computer 800 can be connected to a storage device 818 that provides non-volatile storage for the computer. The storage device 818 can store an operating system 820, programs 822, and data, which have been described in greater detail herein. The storage device 818 can be connected to the computer 800 through a storage controller 814 connected to the chipset 806. The storage device 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 800 can store data on the storage device 818 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 818 is characterized as primary or secondary storage, and the like.

For example, the computer 800 can store information to the storage device 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 800 can further read information from the storage device 818 by detecting the physical states or characteristics of one or more particular locations within the physical storage units.

In addition to the mass storage device 818 described above, the computer 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 800. In some examples, the operations performed by the network controller 106, the network device 108, and or any components included therein, may be supported by one or more devices similar to computer 800. Stated otherwise, some or all of the operations performed by network controller 106 and/or the network device 108, and or any components included therein, may be performed by one or more computer devices 800.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 818 can store an operating system 820 utilized to control the operation of the computer 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 818 can store other system or application programs and data utilized by the computer 800.

In one embodiment, the storage device 818 or other computer-readable storage media is encoded with computer-executable instructions which, when loaded into the computer 800, transform the computer from a general-purpose computing system into a special-purpose computer capable of implementing the embodiments described herein. These computer-executable instructions transform the computer 800 by specifying how the CPUs 804 transition between states, as described above. According to one embodiment, the computer 800 has access to computer-readable storage media storing computer-executable instructions which, when executed by the computer 800, perform the various processes described above with regard to FIGS. 1-7B. The computer 800 can also include computer-readable storage media having instructions stored thereupon for performing any of the other computer-implemented operations described herein.

The computer 800 can also include one or more input/output controllers 816 for receiving and processing input from a number of input devices, such as a keyboard, a mouse, a touchpad, a touch screen, an electronic stylus, or other type of input device. Similarly, an input/output controller 816 can provide output to a display, such as a computer monitor, a flat-panel display, a digital projector, a printer, or other type of output device. It will be appreciated that the computer 800 might not include all of the components shown in the Figures, can include other components that are not explicitly shown in FIG. 8, or might utilize an architecture completely different than that shown in FIG. 8.

As described herein, the computer 800 may comprise one or more of a network controller 106, the network device 108, and/or any other device. The computer 800 may include one or more hardware processors 804 (processors) configured to execute one or more stored instructions. The processor(s) 804 may comprise one or more cores. Further, the computer 800 may include one or more network interfaces configured to provide communications between the computer 800 and other devices, such as the communications described herein as being performed by the network controller 106 and/or the network device 108. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 822 may comprise any type of programs or processes to perform the techniques described in this disclosure.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for utilizing a language model to manage a network, the method comprising:
deploying the language model that is configured to respond to prompts from network operators associated with the network;
collecting configuration data from network devices in the network, the configuration data including device configurations of the network devices;
receiving a prompt from a network operator to which the language model is to respond;
identifying, from the device configurations, a relevant device configuration that is contextually relevant to the prompt;
providing the prompt and the relevant device configuration to the language model;
generating, by the language model and using the relevant device configuration, a response to the prompt; and
providing the network operator with an indication of the response to the prompt.

2. The method of claim 1, further comprising:
generating, using the configuration data, embeddings representing the device configurations of the network devices; and
storing, in a vector database associated with the language model, the embeddings representing the device configurations,
wherein identifying, from the device configurations, the relevant device configuration that is contextually relevant to the prompt includes performing a similarity search of the vector database with at least a portion of the prompt.

3. The method of claim 2, wherein the configuration data is in a computer-readable format, further comprising:
using the language model, converting the configuration data from the computer-readable format into a natural-language format, wherein the prompt is received in the natural-language format; and
generating a first embedding that represents the prompt,
wherein performing the similarity search includes determining that a similarly between the first embedding and a second embedding representing the relevant device configuration is greater than a threshold similarity.

4. The method of claim 2, further comprising:
receiving updated configuration data indicating a change to the configuration data, the updated configuration data representing at least one of:
a change to a device configuration;
an addition of a new network device to the network;
a removal of an existing network device to the network; or
a change in topology of the network; and
updating the embeddings in the vector database to represent the change to the configuration data indicated by the updated configuration data.

5. The method of claim 1, further comprising:
determining that the prompt includes an instruction to automate a network task on behalf of the network operator;
querying network policies managed by a controller of the network to identify a network policy related to the network task;
providing the language model with the network policy; and
generating, by the language model and using the network policy, configuration templates of an automation script that is usable to perform the network task and that is compliant with the network policy.

6. The method of claim 5, further comprising:
using the language model, engaging the network operator in a conversation to determine the automation script that is usable to perform the network task, wherein the conversation includes providing the network operator with a contextually relevant question generated using the language model and regarding the network task;
determining, from the conversation, a semantic preference of the network operator; and
recording, in a local preference document referenced by the language model, the semantic preference of the network operator.

7. The method of claim 1, wherein the language model is deployed to at least one of:
a controller that manages the network; or
a switch included in the network.

8. A system that utilizes a language model to manage a network, the system comprising:
one or more processors; and
one or more non-transitory computer-readable media storing computer-executable instructions that, when executed by the one or more processors, cause the one or more processors to perform operations comprising:
deploying the language model that is configured to respond to prompts from network operators associated with the network;
collecting configuration data from network devices in the network, the configuration data including device configurations of the network devices;
receiving a prompt from a network operator to which the language model is to respond;
identifying, from the device configurations, a relevant device configuration that is contextually relevant to the prompt;
providing the prompt and the relevant device configuration to the language model;
generating, by the language model and using the relevant device configuration, a response to the prompt; and
providing the network operator with an indication of the response to the prompt.

9. The system of claim 8, the operations further comprising:
generating, using the configuration data, embeddings representing the device configurations of the network devices; and
storing, in a vector database associated with the language model, the embeddings representing the device configurations,
wherein identifying, from the device configurations, the relevant device configuration that is contextually relevant to the prompt includes performing a similarity search of the vector database with at least a portion of the prompt.

10. The system of claim 9, wherein the configuration data is in a computer-readable format, the operations further comprising:
using the language model, converting the configuration data from the computer-readable format into a natural-language format, wherein the prompt is received in the natural-language format; and
generating a first embedding that represents the prompt,
wherein performing the similarity search includes determining that a similarly between the first embedding and a second embedding representing the relevant device configuration is greater than a threshold similarity.

11. The system of claim 9, the operations further comprising:
receiving updated configuration data indicating a change to the configuration data, the updated configuration data representing at least one of:
a change to a device configuration;
an addition of a new network device to the network;
a removal of an existing network device to the network; or
a change in topology of the network; and
updating the embeddings in the vector database to represent the change to the configuration data indicated by the updated configuration data.

12. The system of claim 8, the operations further comprising:
determining that the prompt includes an instruction to automate a network task on behalf of the network operator;
querying network policies managed by a controller of the network to identify a network policy related to the network task;
providing the language model with the network policy; and
generating, by the language model and using the network policy, configuration templates of an automation script that is usable to perform the network task and that is compliant with the network policy.

13. The system of claim 12, the operations further comprising:
using the language model, engaging the network operator in a conversation to determine the automation script that is usable to perform the network task, wherein the conversation includes providing the network operator with a contextually relevant question generated using the language model and regarding the network task;
determining, from the conversation, a semantic preference of the network operator; and
recording, in a local preference document referenced by the language model, the semantic preference of the network operator.

14. The system of claim 8, wherein the language model is deployed to at least one of:
a controller that manages the network; or
a switch included in the network.

15. A computer-implemented method comprising:
deploying a language model that is configured to respond to prompts from network operators associated with a network;
collecting network data for the network, the network data indicating network operating conditions of the network;
receiving a prompt from a network operator to which the language model is to respond;
identifying, from the network data, a relevant network operating condition that is contextually relevant to the prompt;
generating, by the language model and using the relevant network operating condition, a response to the prompt; and
providing the network operator with an indication of the response to the prompt.

16. The computer-implemented method of claim 15, wherein the network data includes:
topology data indicating a topology of network elements in the network; or
device configuration data indicating device configurations of the network elements.

17. The computer-implemented method of claim 15, wherein the network data is in a computer-readable format, further comprising:
generating, using the network data, embeddings representing the network operating conditions of the network; and
storing, in a vector database associated with the language model, the embeddings representing the network operating conditions,
wherein identifying the relevant network operating condition that is contextually relevant to the prompt includes performing a similarity search of the vector database with at least a portion of the prompt.

18. The computer-implemented method of claim 17, wherein the network data is in a computer-readable format, further comprising:
using the language model, converting the network data from the computer-readable format into a natural-language format, wherein the prompt is received in the natural-language format; and
generating a first embedding that represents the prompt,
wherein performing the similarity search includes determining that a similarly between the first embedding and a second embedding representing the relevant network operating condition is greater than a threshold similarity.

19. The computer-implemented method of claim 15, further comprising:
determining that the prompt includes an instruction to automate a network task on behalf of the network operator;
querying network policies managed by a controller of the network to identify a network policy related to the network task;
providing the language model with the network policy; and
generating, by the language model and using the network policy, configuration templates of an automation script that is usable to perform the network task and that is compliant with the network policy.

20. The computer-implemented method of claim 19, further comprising:
using the language model, engaging the network operator in a conversation to determine the automation script that is usable to perform the network task, wherein the conversation includes providing the network operator with a contextually relevant question generated using the language model and regarding the network task;
determining, from the conversation, a semantic preference of the network operator; and
recording, in a local preference document referenced by the language model, the semantic preference of the network operator.
